(19) United States
(12) Patent Application Publication
(10) Pub. No.: US 2007/0008067 A1
(43) Pub. Date: Jan. 11, 2007

(54) REMOTE CONTROL TRANSMITTER

(75) Inventor: Atsushi SUZUKI, Osaka (JP)

Correspondence Address: THE RAFFERTY PATENT LAW FIRM, 5641 BURKE CENTRE PKWY, SUITE 100, BURKE, VA, 22015-1731, US

(73) Assignee: FUNAI ELECTRIC CO., LTD., Osaka (JP)

(21) Appl. No.: 11/456,209

(22) Filed: Jul. 9, 2006

(30) Foreign Application Priority Data
Jul. 11, 2005 (JP) 2005-201259

(51) Int. Cl. G05B 19/00

(52) U.S. Cl. 340/5.64

(57) ABSTRACT

A remote control transmitter is capable of performing remote control reliably with an inexpensive structure, in which a light-emitting element having an approximately bombshell-shaped translucent body including translucent resin and a lighting element main body incorporated in the rear part of the translucent body are provided in the front surface of a remote controller main body. The light-emitting element emits a light beam with a signal superimposed thereon when an operation part on the remote controller main body is operated, and an angle widening unit for widening the projection angle of the light beam emitted from the light-emitting element on the optical axis of the light beam is provided. The angle widening unit includes an inwardly tapered hole recessed in the front surface of the translucent body and a half mirror formed on the inner peripheral surface of the tapered hole, in which the angle widening unit reflects the light beam at the half mirror in order to widen the projection angle of the light beam.

### BACKGROUND

1. Introduction

The present discussion relates to a remote control transmitter for remotely controlling an electronic device such as a disk apparatus (for example, a digital versatile disc (DVD) player or recorder) or a television (TV) receiver, in which the remote control transmitter is capable of reliably performing remote control of the electronic device and has an inexpensive structure.

2. Description of the Related Art

A conventional remote control transmitter 101 is shown in FIG. 11. An infrared light-emitting element 20 (such as a light-emitting diode) is provided at the front surface 1a of a remote controller main body 1, in which the light-emitting element 20 emits a light beam “a” with a signal superimposed thereon when an operation part 2 having various push buttons 2a on the remote controller main body 1 is operated. Then, the remote control 101 remotely controls an electronic device 50 such as a disk apparatus (DVD player and DVD recorder) or a TV receiver when the light beam “a” is received at a light-receiving part 55 of the electronic device 50.

In the arrangement noted above, since the light beam “a” emitted from the light-emitting element 20 has a narrow projection angle α due to the straightness of the light-emitting element 20, there may be inconvenience because even a small misalignment between the orientation of the light-emitting element 20 and the light-receiving part 55 of the electronic device 50 makes it impossible for the light-receiving part 55 to receive the light beam “a,” and thus the electronic device 50 makes no response.

One approach for addressing this problem is described in Japanese Patent Laid-Open Publication No. Sho 64-51796, for example, which is hereby incorporated by reference into the present application in its entirety. In that approach, as illustrated in FIG. 11, for example, a half mirror plate 3 for covering the front surface 1a of the remote controller main body 1 is provided in an angularly adjustable manner as indicated by the virtual line in FIG. 11, in which a light beam “aᵢ” (representing a transmitted portion of the total light “a”, in which “a” is the total amount of light emitted from the light-emitting element 20 before reaching the half mirror plate 3) with a signal superimposed thereon is transmitted from the light-emitting element 20 directly forward through the half mirror plate 3, while the other light beam “aᵢᵢ” is reflected by the half mirror plate 3 toward another direction other than forward (in which “aᵢᵢ” represents the reflected portion of the total light “a” that is reflected by, rather than transmitted through, the half mirror plate 3).

The above-described conventional arrangement is not for widening the projection angle α of the light beam “a,” but simply for reflecting the light beam “aᵢᵢ” by the half mirror plate 3 toward, for example, the ceiling inside a car, and causing the reflected beam to reach a light-receiving part 55 of an electronic device 50 so that the electronic device 50 can respond accordingly. That arrangement is therefore useful only when the reflected beam reaches the light-receiving part 55 of the electronic device 50. Also, the half mirror plate 3 used in such an arrangement is large-sized, and thereby expensive, resulting in an increase in production cost.

### SUMMARY

In consideration of the above-described conventional disadvantages, inter alia, a remote control transmitter capable of reliably performing remote control with a relatively inexpensive structure is provided.

In accordance with a first example, a remote control transmitter for controlling an electronic device may include: a remote controller main body; an operation part provided on the remote controller main body; a light-emitting element including an approximately bombshell-shaped translucent body and a lighting element main body incorporated in a rear part of the translucent body, the light-emitting element being provided at a front surface of the remote controller main body, and the light-emitting element being adapted to emit a light beam with a signal superimposed thereon when the operation part is operated; and an angle widening unit for widening a projection angle of the light beam emitted from the light-emitting element on an optical axis of the light beam, the angle widening unit including an inwardly tapered hole provided in a front surface of the translucent body in a recessed manner and a half mirror formed on an inner peripheral surface of the tapered hole, the angle widening unit being adapted to reflect the light beam at the half mirror to widen the projection angle of the light beam.

In accordance with a second example, a remote control transmitter for controlling an electronic device may include: a remote controller main body; an operation part provided on the remote controller main body; a light-emitting element including an approximately bombshell-shaped translucent body and a lighting element main body incorporated in a rear part of the translucent body, the light-emitting element being provided at a front surface of the remote controller main body, and the light-emitting element being adapted to emit a light beam with a signal superimposed thereon when the operation part is operated; and an angle widening unit for widening a projection angle of the light beam emitted from the light-emitting element on an optical axis of the light beam, the angle widening unit including a forwardly tapered translucent cone provided on a front surface of the translucent body in a protruding manner concentrically and integrally with the translucent body and a half mirror formed on an outer peripheral surface of the cone, the angle widening unit being adapted to reflect the light beam at the half mirror to widen the projection angle of the light beam.

In accordance with a third example, a remote control transmitter for controlling an electronic device may include: a remote controller main body; an operation part provided on the remote controller main body; a light-emitting element including an approximately bombshell-shaped translucent body and a lighting element main body incorporated in a rear part of the translucent body, the light-emitting element being provided at a front surface of the remote controller main body, and the light-emitting element being adapted to emit a light beam with a signal superimposed thereon when the operation part is operated; and an angle widening unit for widening a projection angle of the light beam emitted from the light-emitting element on an optical axis of the light beam, the angle widening unit including a translucent front panel detachably positioned on a front surface of the remote controller main body, an inwardly tapered hole provided in a rear surface of the front panel in a recessed manner concentrically with the light-emitting element, and a half mirror formed on an inner peripheral surface of the tapered hole, the angle widening unit being adapted to reflect the light beam at the half mirror to widen a projection angle of the light beam.

In accordance with a fourth example, a remote control transmitter for controlling an electronic device may include: a remote controller main body; an operation part provided on the remote controller main body; a light-emitting element including an approximately bombshell-shaped translucent body and a lighting element main body incorporated in a rear part of the translucent body, the light-emitting element being provided at a front surface of the remote controller main body, and the light-emitting element being adapted to emit a light beam with a signal superimposed thereon when the operation part is operated; and an angle widening unit for widening a projection angle of the light beam emitted from the light-emitting element on an optical axis of the light beam.

In accordance with a fifth example, the remote control transmitter of the fourth example is modified in such a manner that the angle widening unit further includes a half mirror formed on a front surface of the translucent body and is adapted to reflect the light beam at the half mirror to widen the projection angle of the light beam.

In accordance with a sixth example, the remote control transmitter of the fifth example is modified in such a manner that the half mirror is formed on an outer peripheral surface of a translucent cone to be fitted into an inwardly tapered hole that is provided in the front surface of the translucent body in a recessed manner.

In accordance with a seventh example, the remote control transmitter of the fifth example is modified in such a manner that the half mirror is formed on an inner peripheral surface of an inwardly tapered hole that is provided in the front surface of the translucent body in a recessed manner.

In accordance with an eighth example, the remote control transmitter of the fifth example is modified in such a manner that the half mirror is formed on an outer peripheral surface of a forwardly tapered translucent cone that is provided on the front surface of the translucent body in a protruding manner concentrically and integrally with the translucent body.

In accordance with a ninth example, the remote control transmitter of the fourth example is modified in such a manner that the angle widening unit further includes a translucent front panel detachably positioned on the front surface of the remote controller main body and a half mirror formed in a portion of the front panel that faces the light-emitting element, and in which the angle widening unit is adapted to reflect the light beam at the half mirror to widen the projection angle of the light beam.

In accordance with a tenth example, the remote control transmitter of the ninth example is modified in such a manner that the half mirror is formed on an outer peripheral surface of a translucent cone to be fitted into an inwardly tapered hole that is provided in a front surface of the translucent front panel in a recessed manner concentrically with the light-emitting element.

In accordance with an eleventh example, the remote control transmitter of the ninth example is modified in such a manner that the half mirror is formed on an inner peripheral surface of an inwardly tapered hole that is provided in a front surface of the front panel in a recessed manner.

In accordance with a twelfth example, the remote control transmitter of the ninth example is modified in such a manner that the half mirror is formed on an outer peripheral surface of a translucent cone to be fitted into an inwardly tapered hole that is provided in a rear surface of the front panel in a recessed manner concentrically with the light-emitting element.

In accordance with a thirteenth example, the remote control transmitter of the ninth example is modified in such a manner that the half mirror is formed on an inner peripheral surface of an inwardly tapered hole that is provided in a rear surface of the front panel in a recessed manner.

With regard to the first example, since the light beam emitted from the light-emitting element is reflected at the half mirror formed on the inner peripheral surface of the tapered hole and the projection angle of the light beam is widened as desired, it is possible to reliably receive the light beam so that the electronic device can respond appropriately, even when there is a small misalignment between the orientation of the light-emitting element and a light-receiving part of the electronic device. Also, the tapered hole is preferably formed in the front surface of the translucent body, which may permit economical manufacture of the remote controller because the number of parts is not necessarily increased.

With regard to the second example, and further to the above-noted discussion of the first example, the cone is provided integrally on the front surface of the translucent body in a protruding manner, which also may contribute to economical production without necessarily increasing the number of parts.

With regard to the third example, and further to the above-noted discussion of the first example, production costs may be reduced since the half mirror is formed only partially within the tapered hole in the translucent front panel at an extremely small area. Also, the remote control transmitter is very easy to use because the front panel is attached to the front surface of the existing remote controller main body. In addition, appearance may be improved because the tapered hole is formed in the rear surface of the front panel and is not exposed to the outside.

With regard to the fourth example, it is possible for the electronic device to receive the light beam reliably and respond appropriately even when there is a small misalignment between the orientation of the light-emitting element and the light-receiving part of the electronic device, since the projection angle of the light beam emitted from the light-emitting element is widened by the angle widening unit.

With regard to the fifth example, the light beam can be reflected at the half mirror so that the projection angle of the light beam is widened as desired, and production costs may be reduced because the half mirror is formed utilizing the translucent body of the light-emitting element at an extremely small area.

With regard to the sixth example, the light beam can be reflected at the half mirror formed on the outer peripheral surface of the translucent cone so that the projection angle of the light beam is widened as desired. Furthermore, the appearance of the light-emitting element may be improved because the cone is fitted into the inwardly tapered hole that is provided in the front surface of the translucent body of the light-emitting element in a recessed manner, therefore making the cone unnoticeable. In addition, since the cone fills in the tapered hole, the tapered hole cannot get dusty and thus the light beam can be emitted reliably for a long period of time.

With regard to the seventh example, the light beam can be reflected at the half mirror formed on the inner peripheral surface of the tapered hole so that the projection angle of the light beam is widened as desired. Also, the tapered hole is formed in the front surface of the translucent body, which may contribute to cost reduction by not necessarily increasing the number of parts.

With regard to the eighth example, the light beam can be reflected at the half mirror formed on the outer peripheral surface of the translucent cone so that the projection angle of the light beam is widened as desired. Further, the cone is provided integrally on the front surface of the translucent body in a protruding manner, which may contribute to cost reduction by not necessarily increasing the number of parts.

With regard to the ninth example, the light beam can be reflected at the half mirror so that the projection angle of the light beam is widened as desired. In addition, production cost may be reduced because the half mirror is formed only partially in a portion of the translucent front panel arranged on the front surface of the remote controller main body that faces the light-emitting element at an extremely small area. Also, ease of use may be enhanced because the front panel is attached to the front surface of the existing remote controller main body.

With regard to the tenth example, the light beam can be reflected at the half mirror formed on the outer peripheral surface of the translucent cone so that the projection angle of the light beam is widened as desired. Further, appearance may be improved because the cone is fitted into the inwardly tapered hole that is provided in the front surface of the front panel in a recessed manner, therefore making the cone is unnoticeable. In addition, since the cone fills in the tapered hole, the tapered hole cannot get dusty and thus the light beam can be emitted reliably for a long period of time.

With regard to the eleventh example, the light beam can be reflected at the half mirror formed on the inner peripheral surface of the tapered hole so that the projection angle of the light beam is widened as desired. Also, production cost may be made more economical because the tapered hole is formed in the front surface of the front panel, which does not necessarily increase the number of parts, except for the front panel.

With regard to the twelfth example, and further to the above-noted discussion of the tenth example, appearance may be enhanced because the tapered hole and the cone are not exposed to the outside of the front panel.

With regard to the thirteenth example, and further to the above-noted discussion of the eleventh example, appearance may be enhanced because the tapered hole is formed in the rear surface of the front panel and not exposed to the outside.

### BRIEF DESCRIPTION OF THE DRAWINGS

FIG. 1 is a perspective view showing a remote control transmitter according to a first embodiment;

FIG. 2(a) is a disassembled perspective view of a section of the remote control transmitter shown in FIG. 1;

FIG. 2(b) is a partially cutaway side view of the section section shown in FIG. 2(a);

FIG. 3(a) is a perspective view showing a section of a remote control transmitter according to a second embodiment;

FIG. 3(b) is a partially cutaway side view of the section shown in FIG. 3(a);

FIG. 4(a) is a perspective view showing a section of a remote control transmitter according to a third embodiment;

FIG. 4(b) is a partially cutaway side view of the section shown in FIG. 4(a);

FIG. 5 is a perspective view showing a remote control transmitter according to a fourth embodiment;

FIG. 6(a) is a cross-sectional side view of the front part of a remote controller main body of the remote control transmitter;

FIG. 6(b) is a cross-sectional plan view of the front part of the remote controller main body;

FIG. 7(a) is a disassembled perspective view of a section of the front part of the remote controller main body;

FIG. 7(b) is a partially cutaway side view of the section of the remote controller main body shown in FIG. 7(a);

FIG. 8(a) is a perspective view showing a section of a remote control transmitter according to a fifth embodiment;

FIG. 8(b) is a partially cutaway side view of the section of the remote control transmitter shown in FIG. 8(a);

FIG. 9(a) is a disassembled perspective view showing a section of a remote control transmitter according to a sixth embodiment;

FIG. 9(b) is a partially cutaway side view of the section shown in FIG. 9(a);

FIG. 10(a) is a perspective view showing a section of a remote control transmitter according to a seventh embodiment;

FIG. 10(b) is a partially cutaway side view of the section shown in FIG. 10(a); and

FIG. 11 is a perspective view showing a conventional remote controller.

### DESCRIPTION OF THE PREFERRED EMBODIMENTS

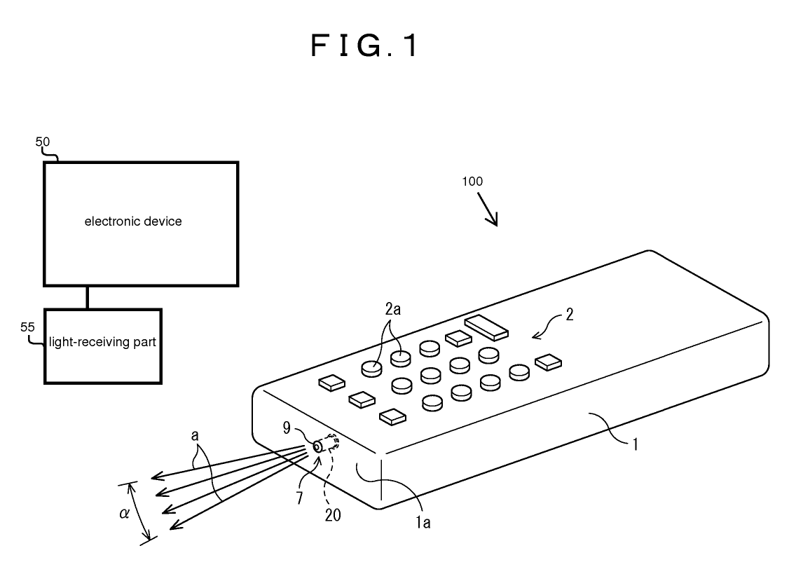

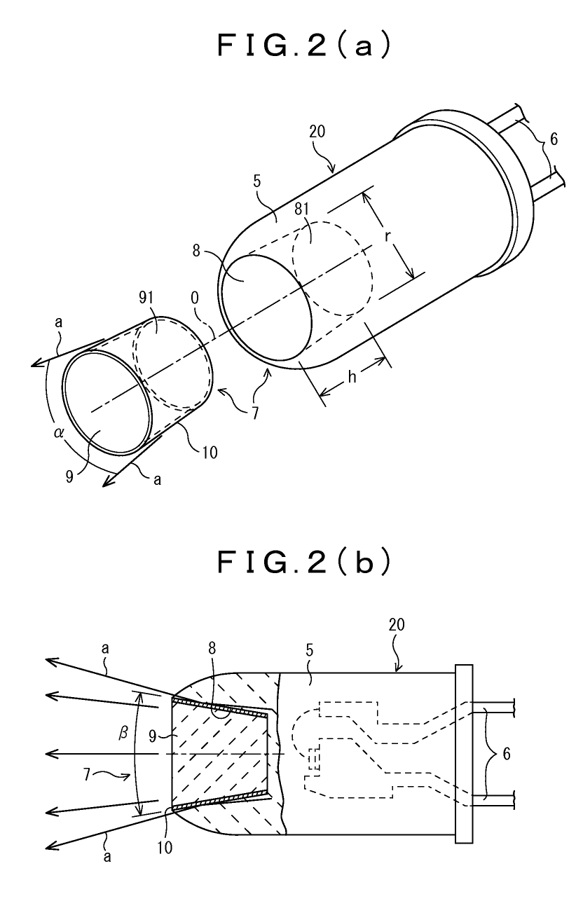

FIGS. 1, 2(a) and 2(b) show a remote control transmitter 100 according to a first embodiment, in which a light-emitting element 20 provided in the front surface 1a of a remote controller main body 1 includes an approximately bombshell-shaped translucent body 5 made of translucent resin such as epoxy resin and a lighting element main body 6 incorporated in the rear part of the translucent body 5, and an angle widening unit 7 for widening the projection angle α of a light beam “a” emitted from the light-emitting element 20 on the optical axis O of the light beam “a.” The remote control transmitter 100 also includes an operation part 2, which has various push buttons 2a for operating the remote control transmitter 100.

The angle widening unit 7 includes, inter alia, an inwardly tapered hole 8 provided in the front surface of the translucent body 5 in a recessed manner; a translucent cone 9 to be fitted into the tapered hole 8; and a half mirror 10 formed on the outer peripheral surface of the cone 9, the cone 9 being formed of translucent resin such as epoxy resin in a truncated conical shape and filling in the opening portion of the tapered hole 8. The half mirror 10 (which may have any suitable optical transmittance and/or reflectivity characteristics) is formed by evaporating metal such as INCONEL® or aluminum, or a dielectric substance, onto the outer peripheral surface of the cone 9, and the optical transmittance of the half mirror 10 is set to an appropriate value, preferably 50%. Alternatively, for example, the angle widening unit 7 may include a beam splitter of any suitable construction.

In accordance with the arrangement noted above, since the half mirror 10 formed on the outer peripheral surface of the cone 9 can widen the projection angle α of the light beam “a” emitted from the light-emitting element 20 as desired, even when there is a small misalignment between the orientation of the light-emitting element 20 and a light-receiving part 55 of an electronic device 50, it is still possible for the light-receiving part 55 to receive the light beam “a” reliably so that the the electronic device 50 can make an appropriate response. Also, since the half mirror 10 is formed on an extremely small area so as to utilize the front surface of the translucent body 5 of the light-emitting element 20 production costs can be reduced. Further, since the cone 9 is fitted into the inwardly tapered hole 8 that is provided in the front surface of the translucent body 5 in a recessed manner, therefore the cone 9 is unnoticeable, and it is possible for the light-emitting element 20 to attain a good appearance. In addition, since the cone 9 fills in the tapered hole 8, the tapered hole 8 cannot get dusty and thus the light beam “a” can be emitted reliably over a long service life.

As specific dimensional examples, the deeper surface 81 (i.e., the planar disc-shaped face that is nearest to the lighting element main body 6, for example) of the tapered hole 8 (and the smaller planar surface 91 of the cone 9) has an outside diameter “r” selected from the range of 1.5 mm to 3 mm; the tapered hole 8 (and the cone 9) has a depth (height) “h” selected from the range of 2 mm to 3.5 mm; and the tapered hole 8 (and the cone 9) has a taper angle β selected from the range of 13 degrees to 23 degrees (preferably selected from 16 degrees to 20 degrees). If the taper angle β is smaller than 13 degrees, the projection angle α of the light beam “a” cannot be sufficiently widened, resulting in a low light-receiving rate at the light-receiving part 55 of the electronic device 50, while if the taper angle β is greater than 23 degrees, the projection angle α of the light beam “a” becomes too widened, which causes difficulty in transmitting the signal on the light beam “a” to the light-receiving part 55 of the electronic device 50. Setting the taper angle β within the range of 13 degrees to 23 degrees (preferably 16 degrees to 20 degrees) allows the light beam “a” to be received reliably at the light-receiving part 55 of the electronic device 50.

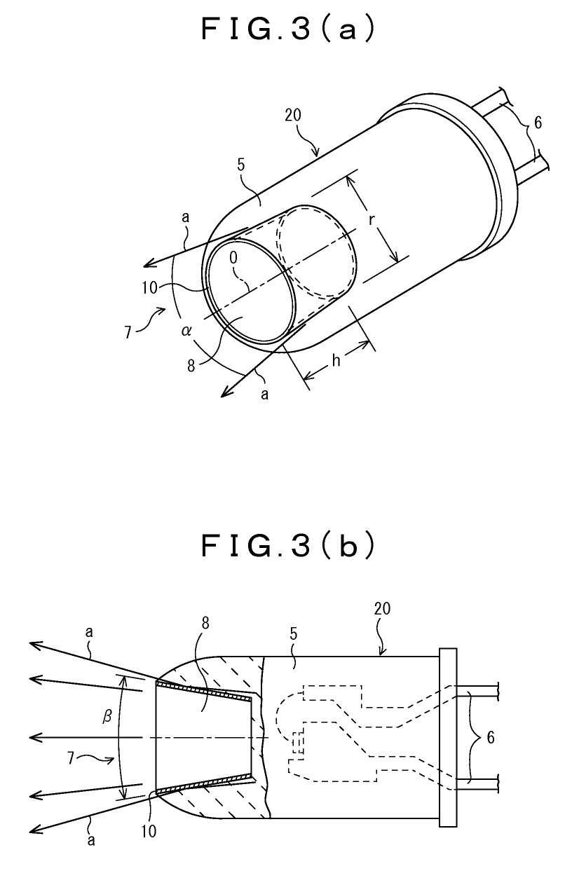

FIGS. 3(a) and 3(b) show a section of a remote control transmitter 100 according to a second embodiment, in which a half mirror 10 is formed on the inner peripheral surface of an inwardly tapered hole 8 that is provided in the front surface of a translucent body 5 in a recessed manner. Other aspects of this embodiment may generally be similar to the first embodiment except that the cone 9 is not provided.

In accordance with the arrangement noted above, the light beam “a” can be reflected at the half mirror 10 formed on the inner peripheral surface of the tapered hole 8 so that the projection angle α of the light beam “a” is widened as desired, as is the case in the first embodiment, for example; and furthermore, production costs may be economized because the tapered hole 8 is formed in the front surface of the translucent body 5, which does not increase the number of parts.

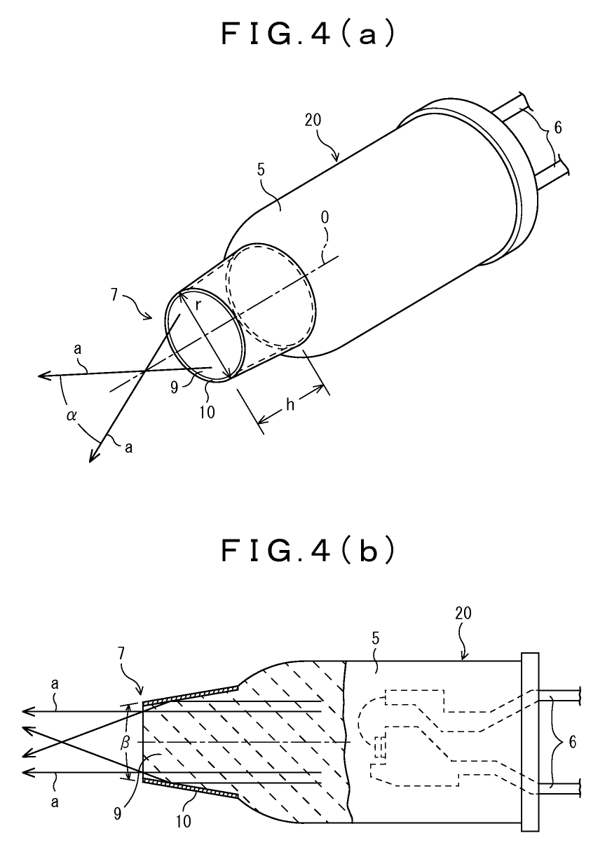

FIGS. 4(a) and 4(b) show a section of a remote control transmitter 100 according to a third embodiment, in which a half mirror 10 is formed on the outer peripheral surface of a forwardly tapered translucent cone 9 that is provided on the front surface of a translucent body 5 in a protruding manner concentrically and integrally with the translucent body 5. Other aspects of this embodiment may be generally similar to the first embodiment except for this different arrangement.

In accordance with the arrangement noted above, the light beam “a” can be reflected at the half mirror 10 formed on the outer peripheral surface of the translucent cone 9 so that the projection angle α of the light beam “a” is widened as desired, as is the case in the first embodiment, for example; and in addition, production costs may be economized because the cone 9 is provided integrally on the front surface of the translucent body 5 in a protruding manner, which does not increase the number of parts.

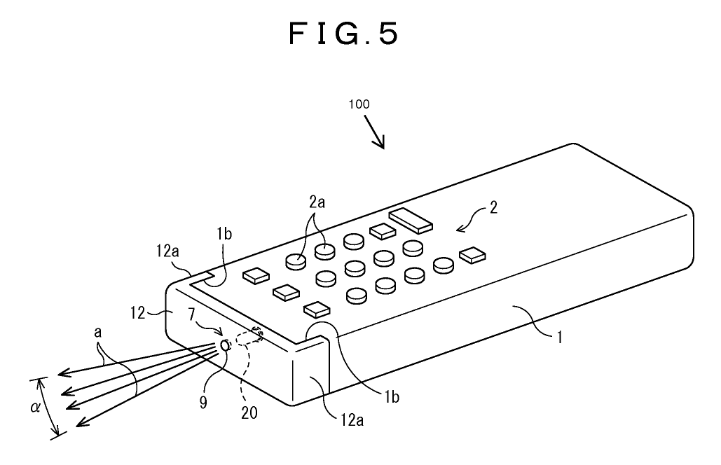

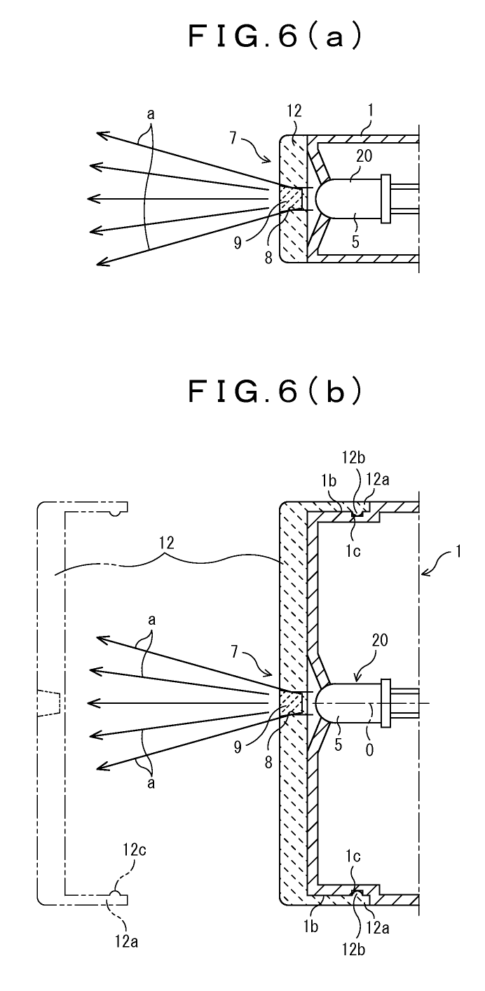

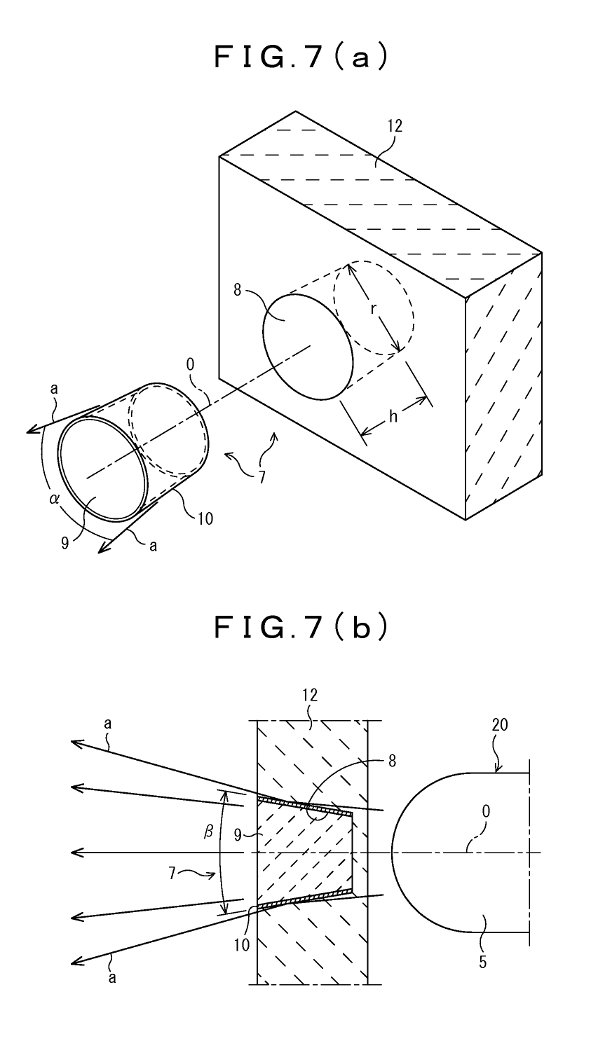

FIGS. 5 to 7(b) show a remote control transmitter 100 according to a fourth embodiment, in which an angle widening unit 7 includes, inter alia, a translucent front panel 12 arranged on the front surface la of a remote controller main body 1; an inwardly tapered hole 8 provided in the front surface of the front panel 12 in a recessed manner concentrically with a light-emitting element 20; a translucent cone 9 to be fitted into the tapered hole 8; and a half mirror 10 formed on the outer peripheral surface of the cone 9. The front panel 12 is formed of translucent resin such as epoxy resin and is arranged detachably on the front surface 1a of the remote controller main body 1 with a pair of left and right side plates 12a extending rearward from opposite lateral ends of the front panel 12, in which the side plates 12a are fitted to concave stepped portions 1b on opposite sides of the front part of the remote controller main body 1, so that protrusions 12b provided integrally on the respective inner faces of the side plates 12a in an inwardly protruding manner are engaged with stopper holes 1c in the respective concave stepped portions 1b. Other aspects of this embodiment may be generally similar to the first embodiment except for this different arrangement.

In accordance with the arrangement noted above, the light beam “a” can be reflected at the half mirror 10 so that the projection angle α of the light beam “a” is widened as desired, as is the case in the first embodiment, for example; and furthermore, since the half mirror 10 is formed only partially in a portion of the translucent front panel 12 arranged on the front surface 1a of the remote controller main body 1 that faces the light-emitting element 20 over an extremely small area, the production cost can be reduced. Also, because the front panel 12 can simply be attached to the front surface 1a of the existing remote controller main body 1, this arrangement can be very easy to use. Further, since the cone 9 is fitted into the inwardly tapered hole 8 that is provided in the front surface of the front panel 12 in a recessed manner, therefore making the cone 9 unnoticeable, it is possible to enhance the appearance of the front panel 12. In addition, since the cone 9 conforms to the tapered hole 8, the tapered hole 8 cannot get dusty and thus the light beam “a” can be emitted reliably over a long service life.

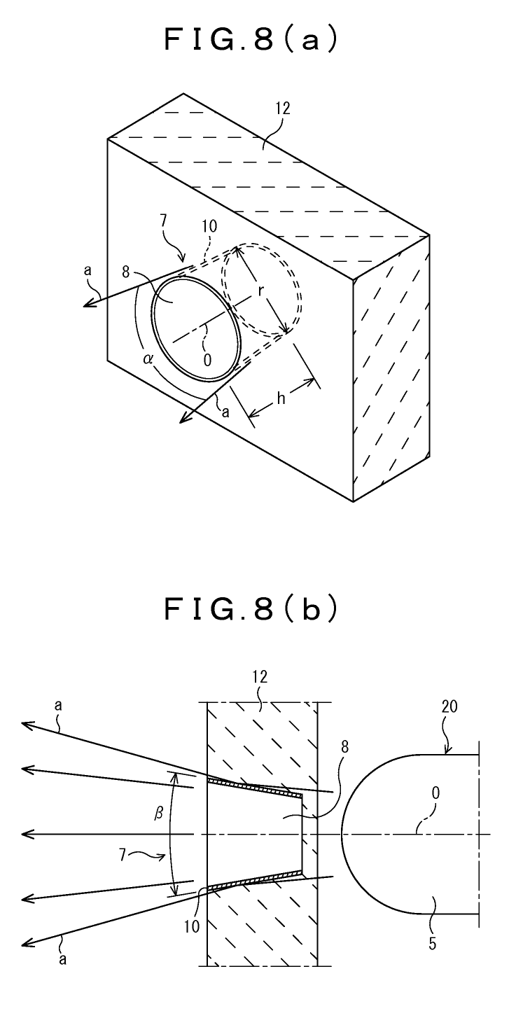

FIGS. 8(a) and 8(b) show a section of a remote control transmitter 100 according to a fifth embodiment, in which a half mirror 10 is formed on the inner peripheral surface of an inwardly tapered hole 8 that is provided in the front surface of a front panel 12 in a recessed manner. Other aspects of this embodiment may be generally similar to the fourth embodiment except that the cone 9 is not provided.

In accordance with the arrangement noted above, the light beam “a” can be reflected at the half mirror 10 formed on the inner peripheral surface of the tapered hole 8 so that the projection angle α of the light beam “a” is widened as desired, as is the case in the fourth embodiment, for example; and furthermore, production costs may be economized because the tapered hole 8 is formed in the front surface of the front panel 12, which does not increase the number of parts, except for the front panel 12.

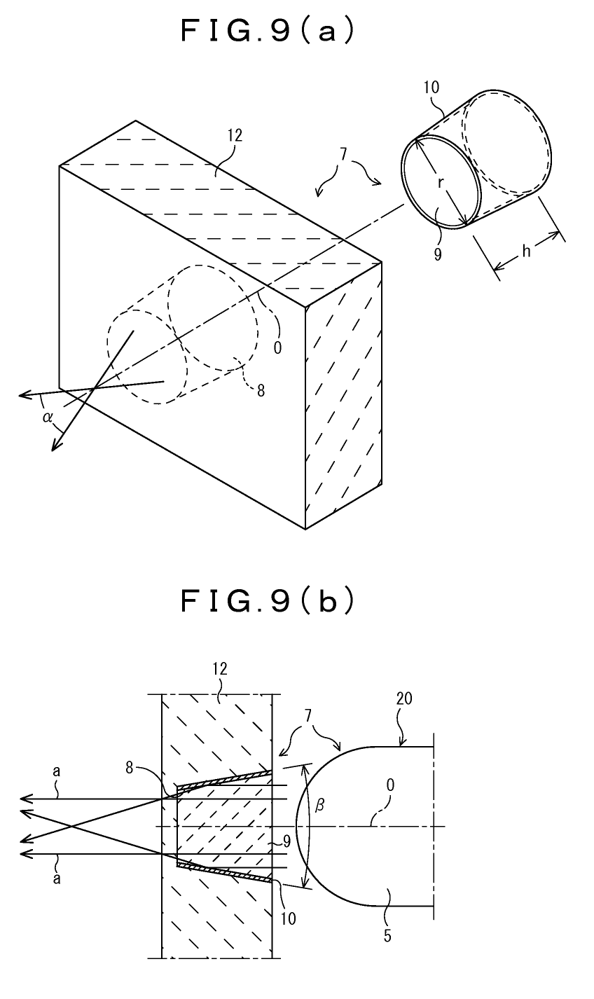

FIGS. 9(a) and 9(b) show a section of a remote control transmitter 100 according to a sixth embodiment, in which a half mirror 10 is formed on the outer peripheral surface of a translucent cone 9 to be fitted into an inwardly tapered hole 8 that is provided in the rear surface of a front panel 12 in a recessed manner concentrically with a light-emitting element 20. Other aspects of this embodiment may be generally similar to the fourth embodiment except that the cone 9 and the tapered hole 8 are in different positions.

In accordance with the arrangement noted above, it is possible to exhibit approximately the same effect as in the fourth embodiment, for example; and in addition, appearance can be improved because the tapered hole 8 and the cone 9 are not exposed to the outside of the front panel 12.

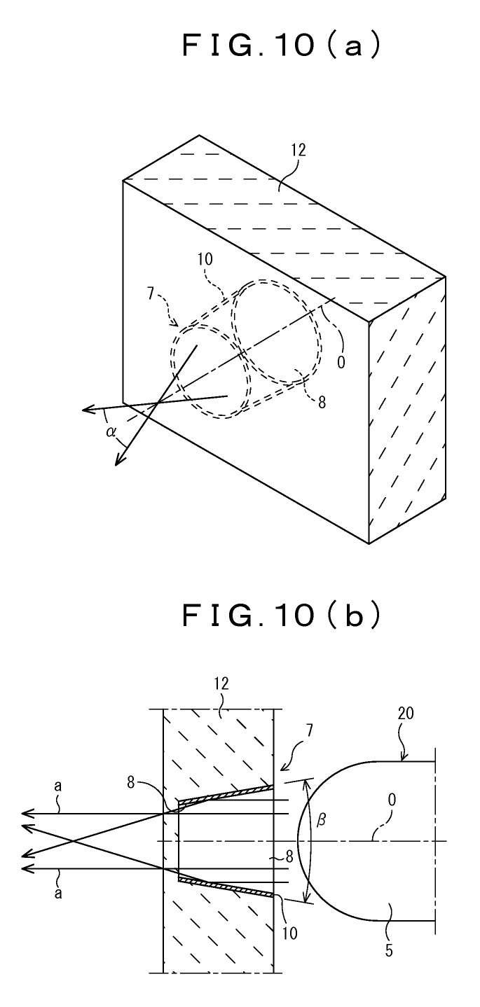

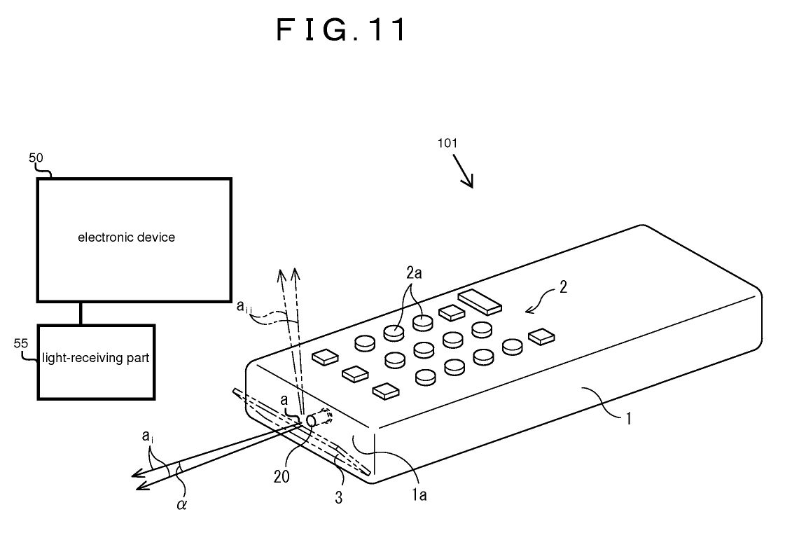

FIG. 10 shows a section of a remote control transmitter 100 according to a seventh embodiment, in which a half mirror 10 is formed on the inner peripheral surface of an inwardly tapered hole 8 that is provided in the rear surface of a front panel 12 in a recessed manner. Other aspects of this embodiment may be generally similar to the sixth embodiment except that the cone 9 is not provided.

In accordance with the arrangement noted above, it is possible to exhibit approximately the same effect as in the fifth embodiment, for example; and furthermore, appearance can be improved because the tapered hole 8 is formed in the rear surface of the front panel 12 and not exposed to the outside.

What is claimed is:

1. A remote control transmitter for controlling an electronic device, comprising:
a remote controller main body;
an operation part provided on the remote controller main body;
a light-emitting element including an approximately bombshell-shaped translucent body and a lighting element main body incorporated in a rear part of said translucent body, the light-emitting element being provided at a front surface of the remote controller main body, and said light-emitting element being adapted to emit a light beam with a signal superimposed thereon when the operation part is operated; and
an angle widening unit configured to widen a projection angle of said light beam emitted from said light-emitting element on an optical axis of said light beam, said angle widening unit including an inwardly tapered hole provided in a front surface of said translucent body in a recessed manner and a half mirror formed on an inner peripheral surface of said tapered hole, the angle widening unit being adapted to reflect said light beam at said half mirror to widen the projection angle of said light beam.

2. A remote control transmitter for controlling an electronic device, comprising:
a remote controller main body;
an operation part provided on the remote controller main body;
a light-emitting element including an approximately bombshell-shaped translucent body and a lighting element main body incorporated in a rear part of said translucent body, the light-emitting element being provided at a front surface of the remote controller main body, and said light-emitting element being adapted to emit a light beam with a signal superimposed thereon when the operation part is operated; and
an angle widening unit configured to widen a projection angle of said light beam emitted from said light-emitting element on an optical axis of said light beam, said angle widening unit including a forwardly tapered translucent cone provided on a front surface of said translucent body in a protruding manner concentrically and integrally with said translucent body and a half mirror formed on an outer peripheral surface of said cone, the angle widening unit being adapted to reflect said light beam at said half mirror to widen the projection angle of said light beam.

3. A remote control transmitter for controlling an electronic device, comprising:
a remote controller main body;
an operation part provided on the remote controller main body;
a light-emitting element including an approximately bombshell-shaped translucent body and a lighting element main body incorporated in a rear part of said translucent body, the light-emitting element being provided at a front surface of the remote controller main body, and said light-emitting element being adapted to emit a light beam with a signal superimposed thereon when the operation part is operated; and
an angle widening unit configured to widen a projection angle of said light beam emitted from said light-emitting element on an optical axis of said light beam, said angle widening unit including a translucent front panel detachably positioned on a front surface of said remote controller main body, an inwardly tapered hole provided in a rear surface of said front panel in a recessed manner concentrically with said light-emitting element, and a half mirror formed on an inner peripheral surface of said tapered hole, the angle widening unit being adapted to reflect said light beam at said half mirror to widen a projection angle of said light beam.

4. A remote control transmitter for controlling an electronic device, comprising:
a remote controller main body;
an operation part provided on the remote controller main body;
a light-emitting element including an approximately bombshell-shaped translucent body and a lighting element main body incorporated in a rear part of said translucent body, the light-emitting element being provided at a front surface of the remote controller main body, and said light-emitting element being adapted to emit a light beam with a signal superimposed thereon when the operation part is operated; and
an angle widening unit configured to widen a projection angle of said light beam emitted from said light-emitting element on an optical axis of said light beam.

5. The remote control transmitter according to claim 4, wherein said angle widening unit further includes a half mirror formed on a front surface of said translucent body, and
wherein the angle widening unit is adapted to reflect said light beam at said half mirror to widen the projection angle of said light beam.

6. The remote control transmitter according to claim 5, wherein said half mirror is formed on an outer peripheral surface of a translucent cone configured to fit into an inwardly tapered hole provided in the front surface of said translucent body in a recessed manner.

7. The remote control transmitter according to claim 5, wherein said half mirror is formed on an inner peripheral surface of an inwardly tapered hole provided in the front surface of said translucent body in a recessed manner.

8. The remote control transmitter according to claim 5, wherein said half mirror is formed on an outer peripheral surface of a forwardly tapered translucent cone provided on the front surface of said translucent body in a protruding manner concentrically and integrally with said translucent body.

9. The remote control transmitter according to claim 4, wherein said angle widening unit further includes a translucent front panel detachably provided on the front surface of said remote controller main body and a half mirror formed in a portion of said front panel that faces said light-emitting element, and
wherein the angle widening unit is adapted to reflect said light beam at said half mirror to widen the projection angle of said light beam.

10. The remote control transmitter according to claim 9, wherein said half mirror is formed on an outer peripheral surface of a translucent cone configured to fit into an inwardly tapered hole that is provided in a front surface of said translucent front panel in a recessed manner concentrically with said light-emitting element.

11. The remote control transmitter according to claim 9, wherein said half mirror is formed on an inner peripheral surface of an inwardly tapered hole that is provided in a front surface of said front panel in a recessed manner.

12. The remote control transmitter according to claim 9, wherein said half mirror is formed on an outer peripheral surface of a translucent cone configured to fit into an inwardly tapered hole that is provided in a rear surface of said front panel in a recessed manner concentrically with said light-emitting element.

13. The remote control transmitter according to claim 9, wherein said half mirror is formed on an inner peripheral surface of an inwardly tapered hole that is provided in a rear surface of said front panel in a recessed manner.

14. The remote control transmitter according to claim 4, wherein the translucent body includes a translucent epoxy resin.

15. The remote control transmitter according to claim 5, wherein the half mirror has an optical transmittance of 50%.

16. The remote control transmitter according to claim 6, wherein the cone flushly fills in the inwardly tapered hole.

17. The remote control transmitter according to claim 6, wherein the inwardly tapered hole includes a deeper surface having a diameter within the range of 1.5 mm to 3 mm, and the inwardly tapered hole has a depth within the range of 2 mm to 3.5 mm, and a taper angle within the range of 13 degrees to 23 degrees.

18. The remote control transmitter according to claim 6, wherein the inwardly tapered hole has a taper angle within the range of 16 degrees to 20 degrees.

19. The remote control transmitter according to claim 9, wherein the front panel includes first and second side plates extending toward the remote controller main body from respective opposite lateral ends of the front panel,
wherein the remote controller main body includes first and second concave stepped portions positioned on opposite sides of a front part of the remote controller main body, and
wherein the side plates include protrusions configured to engage stopper holes positioned in the concave stepped portions of the remote controller main body.

20. The remote control transmitter according to claim 9, wherein the tapered hole and the cone are concealed by the front panel.

21. The remote control transmitter according to claim 13, wherein an exterior of the front panel conceals the tapered hole formed in the rear surface of the front panel.

22. A translucent front panel for detachably engaging a remote control transmitter, comprising:
an angle widening unit configured to widen a projection angle of a signal-encoded light beam emitted from a light-emitting element on an optical axis of the light beam, the light-emitting element being positioned on the remote control transmitter;
a half mirror positioned in the translucent front panel to face the light-emitting element; and
first and second side plates extending from opposite lateral ends of the translucent front panel and configured to detachably engage respective detents on the remote control transmitter.

23. The translucent front panel according to claim 22, wherein said half mirror is formed on an outer peripheral surface of a translucent cone configured to fit into an inwardly tapered hole provided in a front surface of said translucent front panel in a recessed manner concentrically with said light-emitting element.

24. The translucent front panel according to claim 22, wherein said half mirror is formed on an inner peripheral surface of an inwardly tapered hole that is provided in a front surface of said translucent front panel in a recessed manner.

25. The translucent front panel according to claim 22, wherein said half mirror is formed on an outer peripheral surface of a translucent cone configured to fit into an inwardly tapered hole that is provided in a rear surface of said translucent front panel in a recessed manner concentrically with said light-emitting element.

26. The translucent front panel according to claim 22, wherein said half mirror is formed on an inner peripheral surface of an inwardly tapered hole that is provided in a rear surface of said translucent front panel in a recessed manner.
